(19) United States
(12) Patent Application Publication
(10) Pub. No.: US 2002/0022423 A1
(43) Pub. Date: Feb. 21, 2002

(54) Seat cushion with foamed-in elastic insert

(76) Inventors: Bernd Kroening, Adenbuettel (DE); Thomas Prause, Nordstemmen (DE)

Correspondence Address: MCGLEW & TUTTLE, PC, SCARBOROUGH STATION, SCARBOROUGH, NY, 10510, US

(21) Appl. No.: 09/794,695

(22) Filed: Feb. 27, 2001

(30) Foreign Application Priority Data
Mar. 2, 2000 (DE) 100 09 941.6

(51) Int. Cl. D04B 1/00; D04B 7/00; D04B 11/12; B32B 5/18; B32B 5/24; B29C 44/06; B29C 44/12

(52) U.S. Cl. 442/304; 442/306; 442/315; 264/46.6

(57) ABSTRACT

A foam part of an expandable plastic, in particular polyurethane or the like, for use as a cushioning element in a seating surface. The foam material has essentially homogeneous material properties, at least in the core of the foam part, and at least one insert with flat X-Y expansion is foamed into the core of the foam part essentially parallel to the seating surface. The insert is at least partially foamable by the expandable plastic, and has a specific elasticity in the X-direction and/or Y-direction.

### FIELD OF THE INVENTION

The invention relates to a foam part having expandable plastic, in particular polyurethane or the like, for use as a cushioning element in a seating surface. The foam material has essentially homogeneous material properties, at least in the core of the foam part. In addition, the invention relates to a procedure for manufacturing such foam parts.

### BACKGROUND OF THE INVENTION

Such foam parts are manufactured out of expandable plastic, in particular polyurethane or the like, and are used as cushioning elements in seating surfaces with an X-Y expansion. One of the biggest areas of application is in the automobile industry, where generic foam parts are used to cushion vehicle seats. Of course, the foam parts according to the invention can also be used in other areas of application, e.g., in the upholstered furniture industry.

The seating surface, i.e., the surface of the cushioning element on which the bottom or back of an individual comes to rest, hereby defines an X-Y plane, along which the generic foam parts extend. The foam material of the generic foam parts here has essentially homogeneous material properties, at least in the core of the foam part. The material properties in the edge areas of the foam part can deviate from the above, e.g., to obtain foam parts with a closed surface.

In order to optimally ensure the comfort of cushioning elements, in particular in vehicle seats, it is necessary to manufacture foam parts with a specific spring characteristic. Most vehicle manufacturers require a progressive spring characteristic of the foam parts. In other words, the foam parts must be relatively soft as the load is initiated to ensure softness during initial seating. By contrast, a relatively stiff resilience is required under a maximal load, i.e., on application of full body weight, in order to impart a feeling of firmness while sitting.

Cushioning elements that have two differing levels of spring stiffness for the initial and final loads in keeping with these requirements are known in the art, and can be manufactured, for example, by making the upper layer of the foam part out of a softer expanded plastic, and the lower layer out of a harder expanded plastic. In addition, it is possible to incorporate grooves or recesses in the upper layer of the foam part to diminish the spring stiffness of the foam in the upper area. The disadvantage of known measures has to do with the high manufacturing outlay required for making these foam parts.

### SUMMARY AND OBJECTS OF THE INVENTION

The object of the present invention is therefore to propose a foam part with a progressive spring characteristic that is easy to manufacture. In addition, the object of this invention is to propose a procedure for manufacturing such foam parts.

The invention is based on the general idea that an insert can be foamed in to modify the homogeneous material properties of the foam part that result in an approximately linear spring characteristic. To achieve the desired progression of the spring characteristic, at least one insert with flat X-Y expansion is therefore foamed into the core of the foam part essentially parallel to the seating surface according to the invention. The feature of arranging the insert parallel to the seating surface here indicates only the rough orientation of the flat insert, and must not be construed as meaning that the insert is exactly parallel to the seating surface. Rather, the insert can have a slightly curved or deformed arrangement, for example, depending on the required seating geometry.

When selecting the material for the insert, one must make sure that it can be at least partially foamed through by the expandable plastic, and has a specific elasticity in the X and/or Y direction. By at least partially foaming through the insert, the insert becomes securely anchored in the foam part, and does not detach from the core of the foam part, even when the foam part is placed under a load. The foamed-in insert makes it possible to make targeted changes in the elastic properties of the foam part. In particular, the lower foam layers can be made to exhibit a harder spring characteristic, since the deformability of the foam material is limited by the foamed-in insert. By contrast, the spring properties of the upper foam layers largely correspond to the properties of the normal foam, since the deformation of the upper layers remains largely to uninfluenced by the insert. In this case, of course, the insert must have a certain elasticity in the X direction and/or Y direction, since the deformation of the foam part would otherwise be entirely precluded starting at a specific compression path, thereby resulting in cracks and damage to the foam body.

Basically all elastic materials with an essentially two-dimensional expansion can be used as the insert. In particular, commercially available fleeces, wovens or lattices can be used as the inserts, wherein the selection of varying materials depends on the respective application and desired workpiece properties.

In addition, it is conceivable to use knits as the insert. Such knits have an essentially flat expansion, and here exhibit a specific layer thickness in the Z-direction. Since the knits are foamed through by the expanded plastic, this yields a layer in the foam part whose layer thickness corresponds to that of the insert, and whose elastic properties are a combination of properties from the foam and insert. Therefore, increasing the spring stiffness of the foam part by preventing the deformation of the foam with the insert provides an additional way to influence the spring properties of the foam part, since the elastic properties of the knits have a direct influence on the spring characteristic of the foam part.

The knits can be designed basically as desired, tailored to the requirements of the respective application. In one particularly advantageous knit design, the knits have an upper and lower fabric layer extending in the X direction and Y direction. Due to the fabric structure, the knits therefore exhibit the desired elasticity in the X and Y direction. The two fabric layers are here held apart by numerous elastic threads running in the Z direction. After foaming, this yields a layer in the foam part that is bordered by the fabric layers from above and below, inside of which the foam completely envelops the elastic threads running in the Z to direction. Depending on the application, it is conceivable for the insert to extend through the entire core ofthe foam part over essentially the entire surface, or, as an alternative, for one or more inserts to be arranged only partially in specific areas of the core of the foam part. The partial arrangement of inserts in the foam part makes it possible to influence specific zones in the cushioning element in a targeted manner, so that specific location-dependent cushioning characteristics can be achieved.

In specific vehicle types, e.g., sports cars, lateral support cushions are molded onto the foam part of the seat upholstery, which extend upwardly over the seating surface, thereby giving the driver lateral support. These lateral support cushions must be stabilized in a special way to absorb the arising lateral retention forces. To this end, wire parts can be foamed into the foam part, which connect the core of the foam part with the lateral support cushions. When using the inserts according to the invention, the lateral support cushions can be stabilized by having the insert extend from the core of the foam part at least partially into the foam material of the lateral support cushions.

Lateral support cushion stabilization can be further enhanced imparting to the insert prior to refoaming an at least partially dimensionally stabile profiling corresponding to the seating contour of the foam part with molded-on support cushions. The dimensionally stable profiling, which can be patterned in particular after the shape of the lateral support cushions, further diminishes the deformability of the foamed-in insert, so that the support cushions end up having a better hold to the core of the foam part. To achieve the desired profiling of the insert, it is conceivable to use materials in which a stiffening can be achieved in the area of the desired profile edges through heat treatment. For example, knits consisting of thermoplastic material can be used for this purpose, which can be permanently deformed in the area of the desired profile edges via linear heating.

The use of the foamed parts according to the invention for vehicle seats in motor vehicles is particularly advantageous. The foam parts according to the invention can be easily manufactured by foaming the foam parts in a mold consisting of an expandable plastic in a conventional manner, wherein an expandable, elastic insert must be placed into the mold with a flat X-Y expansion before adding the expandable plastic into the mold. Adding the expandable plastic foams the insert into the foam part in the desired position.

The various features of novelty which characterize the invention are pointed out with particularity in the claims annexed to and forming a part of this disclosure. For a better understanding ofthe invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

The invention will be described in greater detail below based on drawings that show only preferred embodiments of the invention. Shown in:

FIG. 1 is a perspective cross-sectional view of the foam part from the side;

FIG. 2 is an alternative embodiment perspective cross-sectional view of the foam part from the front;

FIG. 3 is a graph showing the spring characteristics of the foam part without a foamed-in insert;

FIG. 4 is a graph showing the spring characteristics of the foam part with a foamed-in insert;

### DESCRIPTION OF THE PREFERRED EMBODIMENT

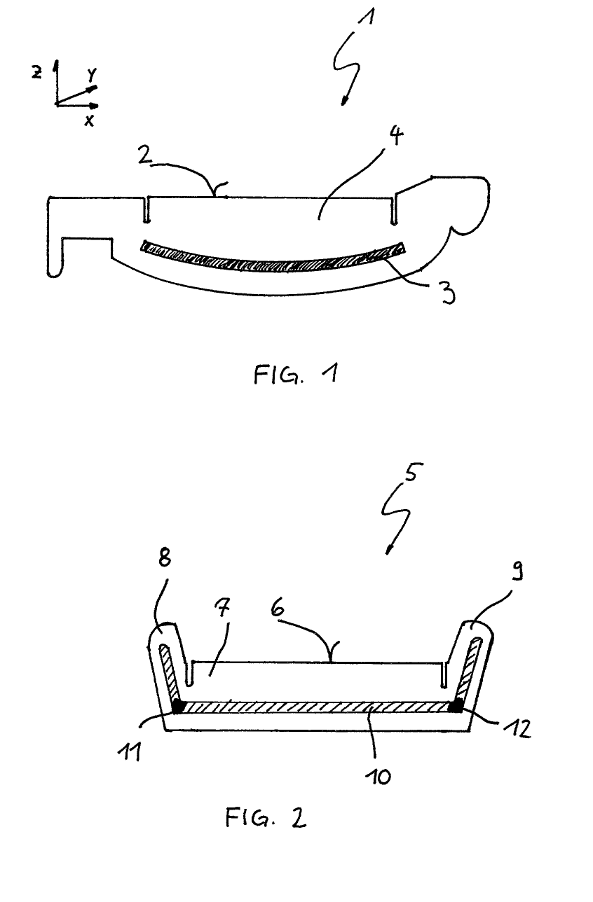

Referring to the drawings in particular, FIG. 1 shows a foam part 1, whose seating surface 2 extends in the X and Y direction. An insert 3 is foamed into the core 4 of the foam part 1 essentially parallel to the seating surface 2. The insert 3 is here formed to by knits whose expansion in an X and Y direction essentially corresponds to the expansion of the seating surface 2, and which has a certain layer thickness in the Z direction. The knits 3 are here completely foamed by the foaming material ofthe foam part 1. The shown foam part is intended for use in a vehicle seat, and serves to hold the bottom of one of the 15 vehicle passengers. A correspondingly designed foam part with insert can of course also be conceived for the area of the seat cushion against which the back of the vehicle passenger rests. The extension of the insert 3 into the core of the foam part 1 is shown only by example in FIG. 1. It is entirely conceivable to extend the insert 2 to the outermost edge of the foam part 1 as well.

FIG. 2 shows a foam part 5 provided for use in a sports car. It shows the seating surface 6 and two support cushions 8 and 9 molded laterally on the core 7 of the foam part 5. An insert 10 extending laterally until into the foam material ofthe support cushions 8 and 9 is foamed into the core 7 of the support cushion 5. The insert 10 is here permanently deformed via heat treatment in the area of the profile edges 11, and 12, which represent the transition from the core 7 of the foam part 5 to the lateral support cushions 8 and 9. This produces a U-shaped profile of the insert 10, making it possible to increase the lateral stabilization of the support cushions 8 and 9.

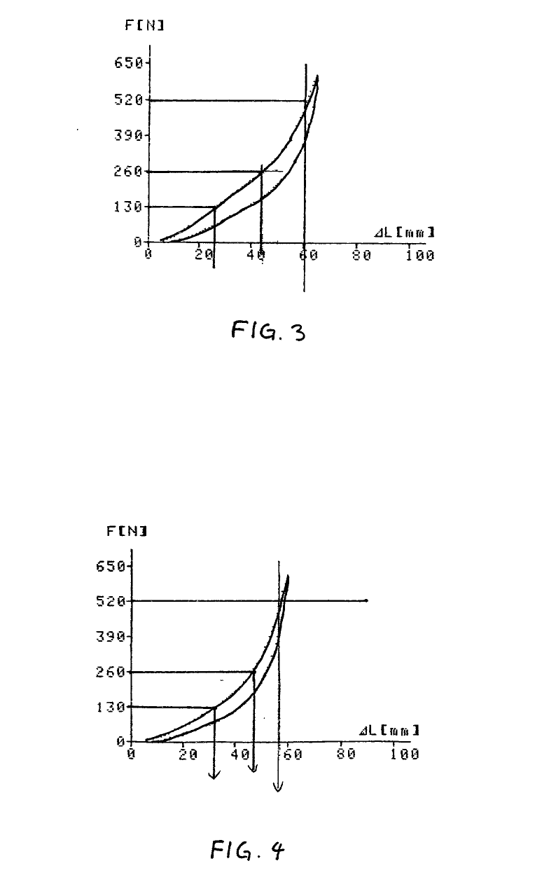

FIG. 3 shows the spring characteristic of a conventional foam part without insert. As evident, the spring resistance ofthe foam part increases almost linearly with rising compression.

Also evident is the spring hysteresis during the rebounding of the foam part, as customary for foam bodies.

By contrast, FIG. 4 shows the spring characteristic of a corresponding foam part with foamed-in insert. As evident, the foam part compresses relatively softly in the lower loading range up to a compression of approximately 30 mm. This corresponds to a deformation of the 20 top layers of the foam part that is not impeded by the foamed-in insert. Starting at a compression path ofapproximately 30 mm, the upper layer ofthe foam part is nearly completely pressed together, and the spring resistance now rises progressively. The more the foam part is compressed, the more the foamed-in insert impedes deformation.

As a result, then, the desired stronger progression of the spring characteristic by comparison to the conventional foam part can be achieved by foaming in the insert, without having to combine foam materials with varying elasticity characteristics.

While specific embodiments of the invention have been shown and described in detail to illustrate the application of the principles of the invention, it will be understood that the invention may be embodied otherwise without departing from such principles.

12. (New) A cushion comprising:
a core having a surface;
an elastic insert arranged in said core of said surface and extending in a substantially in a direction of said seating surface wherein said insert of said core is formed of an expandable plastic and wherein said core and said insert form a cushion.

12. (New) A cushion in according to claim 12, wherein said insert is fleeces, wovens or knits.

13. (New) A cushion in according to claim 12, wherein said insert is a knit layer, having a thickness, with flat expansion.

14. (New) A cushion according to claim 13, wherein the knits have an upper fabric layer and a lower fabric layer, said upper and lower layers are divided by elastic threads.

15. (New) A cushion according to claim 12, wherein the insert extends through the entire core over essentially the entire surface.

16. (New) A cushion according to claim 12, wherein a plurality of the inserts are arranged in the core of the foam part.

17. ( New) A cushion according to claim 12, further comprising a lateral support cushion extending in an essentially orthogonal direction from the seating surface wherein the insert extends from the core through said lateral support cushion.

18. (New) A cushion according to claim 12, wherein the insert has a profiling shape corresponding approximately to the angle the seating surface makes with the support cushion.

19. (New) A cushion according to claim 12, wherein said seat cushion is for vehicle seat for a motor vehicle.

20. (New) A cushion according to claim 12, wherein said expandable plastic is polyurethane or an equivalent.

21. (New) A cushion according to claim 12, wherein said expandable plastic is polyurethane.

22. (New) A cushion according to claim 12, wherein said insert has defined spaces for receiving foam.

23. (New) A process for manufacturing a cushion with a foamed-in insert, the process comprising the steps of:
providing a mold for a cushion;
placing an elastic insert into said mold;
inserting foam material in to said mold to surround said elastic insert by said foam.

24. (New) the process according to claim 21, further comprising the steps of:
heating said insert to create a desired profiled edge.

25. (New) the process according to claim 21, wherein said expandable plastic is polyurethane or equivalent.

26. (New) the process according to claim 21, wherein said expandable plastic is polyurethane.

27. (New) the process according to claim 21, wherein said insert has defined spacesf for receiving foam.

28. (New) A seat cushion comprising:
a core having a seating surface extending in two substantially orthogonal directions;
a foamed-in elastic insert arranged in said core and extending in a direction substantially similar to two said directions of said seating surface wherein said insert of said core is formed of an expandable plastic and wherein said core and said insert form a foam part of said seat cushion, said insert is at least partially foamed through by said expandable plastic.

29. ( New) A seat cushion according to claim 28, further comprising a lateral support cushion molded onto said foam part and extending upwardly over the seating surface, wherein said insert extends from the core at least partially into foam material of the lateral support cushion.
